(19) United States
(12) Patent Application Publication
(10) Pub. No.: US 2009/0013152 A1
(43) Pub. Date: Jan. 8, 2009

(54) COMPUTING UNIT AND IMAGE FILTERING DEVICE

(76) Inventors: Masakazu EHAMA, Ebina (JP); Koji Hosogi, Hiratsuka (JP); Seiji Mochizuki, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/168,416

(22) Filed: Jul. 7, 2008

(30) Foreign Application Priority Data
Jul. 5, 2007 (JP) 2007-177299

(51) Int. Cl. G06F 15/80; G06F 9/02

(52) U.S. Cl. 712/22; 712/E09.002

(57) ABSTRACT

A processor capable of performing a filter processing in a high speed is provided. A computing unit comprises a computer for performing a filter processing. Data supply to the computer is performed by an internal register configured by a flip-flop. Data read from the internal register is outputted to a shift register and the data is supplied to the computer per cycle. And, the computing unit comprises a mechanism for changing a filter computing direction according to a motion vector, thereby preventing performance lowering due to branched command by performing a horizontal filtering and a vertical filtering by a same command.

### CROSS-REFERENCE TO RELATED APPLICATION

The present application claims priority from Japanese Patent Application No. JP 2007-177299 filed on Jul. 5, 2007, the content of which is hereby incorporated by reference into this application.

### TECHNICAL FIELD OF THE INVENTION

The present invention relates to a processor including a command and a circuit to perform an image filtering.

### BACKGROUND OF THE INVENTION

In a moving image, there are motions between frames when an object in the frame or a camera pans, and so a previous frame and a current frame are not exactly the same. However, the previous and next images have a large correlation.

Motion compensation is a technique for analyzing images by using vector data about which direction and how much movements are made as compared with images of the previous and next frames in intra-frame prediction. According to the motion compensation, it is succeeded in improving a degree of compression of image data.

In many of image frame coding methods, an image frame is partitioned in predetermined blocks for processing. When the size of the block is made small, a detail prediction is possible. On the other hand, it makes the number of blocks increased so that the number of motion vector information itself is increased, and thus the amount of encoding has been on an increasing trend. As a result, a large processing ability is required to hardware.

And, when encoding an image at a low bit rate, if no filter processing is performed, a block noise is generated and remained in a decoding image and stored in a frame memory. If the next frames is encoded referring to the image having the noise, there is posed a problem of further propagation of the image degradation. To prevent the propagation of image degradation, it is indispensable to perform filter processing for preventing the generation of block noise. Meanwhile, a large processing ability is required also to hardware to solve the filter processing.

Conventionally, when performing an image filter processing, clock cycles of the number of taps are necessary to perform filtering, and so it is required to supply data from a memory every clock cycle. Further, depending on searching positions of a motion vector, a horizontal filtering and a vertical filtering are changed, and so it has been required to determine the direction of filter processing in every change to bifurcate to a program suitable with the filter processing. At this time, if reading pixel data from the memory in every cycle, the number of read cycles is consumed more than necessary, thereby lowering the processing performance.

Japanese Patent Application Laid-Open Publication No. 2002-8025 (hereinafter, Patent Document 1) suggests a method of supplying data to a computer where the number of data-reads from a memory is reduced and data by an input buffer or the like are accumulated to be supplied to a computer.

### SUMMARY OF THE INVENTION

Meanwhile, if reading pixel data from a memory in an image filter processing, the number of read cycles is consumed more than necessary, thereby lowering the processing performance.

Further, while it is needed to change a horizontal filtering and a vertical filtering corresponding to a motion vector, it is also needed to change the way to read picture images. Therefore, a bifurcated processing is required.

While recent processors prevent processing performance lowering by bifurcated prediction, since it is difficult to make bifurcated prediction in image processing, performance lowering is significant.

Further, as a matter of circuit mounting, it is considered that sufficient number of internal registers may not be prepared to the filter processing.

The present invention has been made to solve the above mentioned problems, and an object of the present invention is to provide a computing unit and an image filtering device capable of performing a high-speed filter processing.

The above and other objects and novel characteristics of the present invention will be apparent from the description of this specification and the accompanying drawings.

The typical ones of the inventions disclosed in this application will be briefly described as follows.

A computing unit according to the present invention comprises: an SIMD computer including a plurality of computers capable of executing a first computing processing for performing one specific processing in a first cycle and a second computing processing for performing another specific processing in a second cycle different from the first cycle; and a command decoder, and the command decoder can define a number of computers to be operated among the plurality of computers according to an entered command code.

The computing unit further comprises a shift register in the SIMD computer, and the command decoder enters data to the shift register according to the entered command code.

Further, the computing unit further comprises an internal register and an index generator outputting address of the internal register according to an input from the command decoder, and data of the internal register can be entered to the shift register referring to the address.

Still further, the first cycle of the computing unit is configured by a predetermined number of clock cycles, and it is possible that a second computation result is outputted per second cycle and data in the shift register is shifted after each clock cycle in the second cycle ends. The computing unit may store the second computation result to the internal register.

The computing unit may enter a first computation result to a second computing processing as the data.

An image filtering device according to the present invention comprises: a shift register; an SIMD computer including a plurality of computers capable of executing a first computing processing for performing one specific processing in a first cycle and a second computing processing for performing another specific processing in a second cycle different from the first cycle; a command decoder; an internal register; an index generator; and a motion vector register. In the image filtering device, the command decoder accumulates motion vector data to the motion vector register and the index generator outputs an address of the internal register referring to an output of the command decoder and the motion vector data, and the data of the internal register is entered to the shift register referring to the address so as to be computed by the SIMD computer.

An image filtering device according to the present invention comprises: a shift register; an SIMD computer including a plurality of computers capable of executing a first computing processing for performing one specific processing in a first cycle and a second computing processing for performing another specific processing in a second cycle different from the first cycle; a motion vector register to which a plurality of motion vector data items are accumulated; a command decoder; an internal register; and an index generator. In the image filtering device, the command decoder defines a number of computers to be operated among the plurality of computers according to an entered command code, the motion vector register outputs proper motion vector data to the index generator according to an output from the command decoder, and the index generator outputs an address of the internal register referring to the output of the command decoder and the motion vector data, and the data of the internal register is entered to the shift register referring to the address so as to be computed by the SIMD computer.

The effects obtained by typical aspects of the present invention will be briefly described below.

A computing unit and an image filtering device according to the present invention can provide reduction of data accesses to a memory regardless of a configuration of hardware by accumulating image data to an internal register and entering the data to a computer, thereby performing a processing efficiently.

And, it is able to provide a computing unit and an image filtering device in which a bifurcated processing is eliminated by performing a filter processing in consideration of motion vector, thereby reducing accesses to a command cache.

Further, since data accesses to a memory and command fetch accesses to a command cache is reduced, it is able to suppress power consumption, thereby providing an environment-friendly computing unit and an image filtering device.

### BRIEF DESCRIPTIONS OF THE DRAWINGS

FIG. 1 is a conceptual diagram describing a 6-tap FIR filter processing and a 2-tap filter processing;

FIG. 2 is a conceptual diagram describing a horizontal 6-tap FIR filter processing according to the present invention;

FIG. 3 is a conceptual diagram describing a vertical 6-tap FIR filter processing according to the present invention;

FIG. 4 is a conceptual diagram describing a diagonal 6-tap FIR filter processing according to the present invention;

FIG. 5 is a conceptual diagram describing a two-tap filter processing according to the present invention;

FIG. 6 is a conceptual diagram showing a data flow of a computing unit according to a first embodiment of the present invention;

FIG. 7 is a configuration diagram showing a configuration of a command code with respect to a computing unit according to the first embodiment of the present invention;

FIG. 8 is a configuration diagram showing a configuration of a processor using the computing unit according to the present invention;

FIG. 9 is a diagram showing an alignment of data by a data aligner included in the computing unit according to the present invention;

FIG. 10 is a diagram showing a flow of a 6-tap FIR filter processing and a 2-tap filter processing of the computing unit according to the first embodiment of the present invention;

FIG. 11 is a conceptual diagram showing a method of storing data simulating the case where the computing unit according to the first embodiment of the present invention stores 14-byte data when an internal register is 10-byte wide;

FIG. 12 is a diagram showing a method of entering the data of FIG. 11 to the computing unit according to the first embodiment of the present invention; and

FIG. 13 is a conceptual diagram showing a data flow of a computing unit according to a second embodiment of the present invention.

### DESCRIPTIONS OF THE PREFERRED EMBODIMENTS

With reference to the accompanying drawings, embodiments of the present invention will be described.

(About Simulated Processing)

First, a motion compensation prediction processing which the present invention simulates will be described.

To perform motion compensation prediction processing, it is general to generate a signal having a pixel precision smaller than or equal to integer pixel through interpolation from the pixel value of a reference picture. It is designed to be able to perform motion compensation to ½ pixel precision in MPEG-2 and MPEG-4, and to ¼ pixel precision in H.264/AVC.

In H.264/AVC, there are two separated derivation steps; to derivate a ½ unit pixel (half-pel) and to derivate a ¼ unit pixel (quarter-pel, Qpel). First, data of a ½ unit pixel is derived from data of a reference image by a computation expression at first (6-tap FIR filter processing). And, a ¼ unit pixel and a ¾ unit pixel are derived from the reference image and the ½ unit pixel derived by 6 taps (2-tap filter processing).

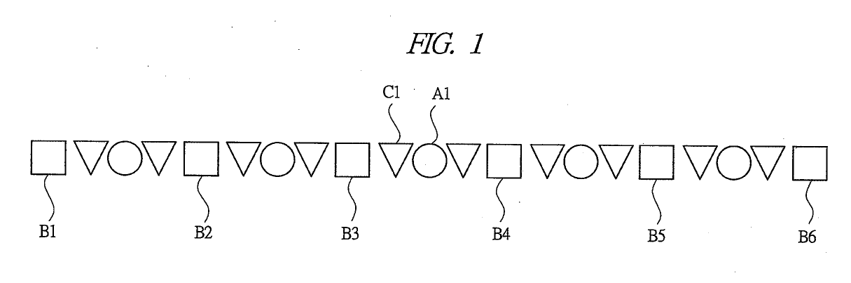

FIG. 1 is a conceptual diagram showing processing contents of the 6-tap FIR filter processing and the 2-tap filter processing from integer pixels. In this diagram, A1 denoted by a circle is a ½ pixel which is an object of the derivation, and B1, B2, B3, B4, B5, B6 each denoted by a square are reference pixels (integer pixels).

Herein, to derive the ½ unit pixel A1, a computation is made using the following expression with the previous and subsequent pixels of the integer pixels B1, B2, B3, B4, B5, B6.

A1=(B1−5×B2+20×B3+20×B4×5×B5+B6+16)/32 (Expression 1)

And, in the 2-tap processing, a ¼ unit pixel C1 denoted by a triangle is derived from the following expression.

C1=(A1+B3+1)/2 (Expression 2)

According to the foregoing, when handling data of 8 pixels wide×8 pixels high by a quarter-pel unit, data of 14 pixels wide×14 pixels high is required as a reference image. It is also required in the present invention.

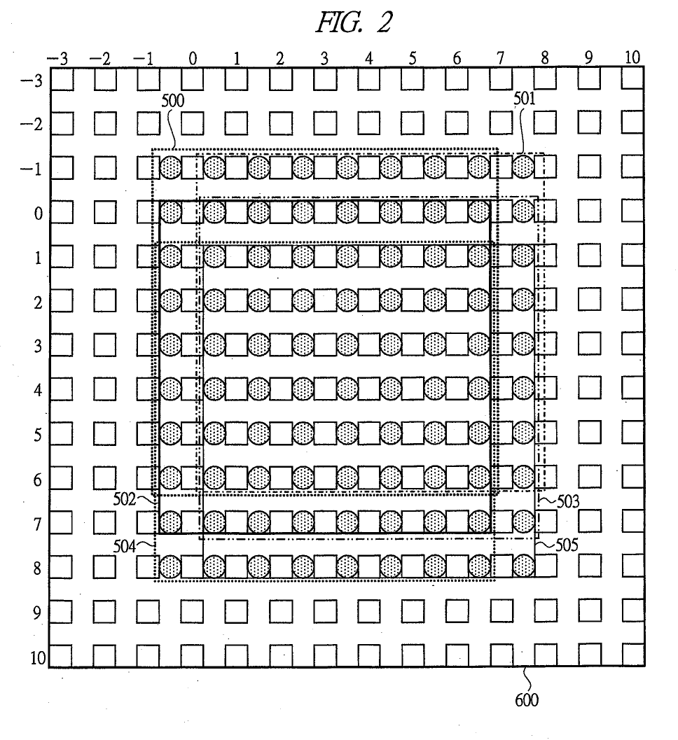

FIG. 2 shows a filter processing for obtaining an image (image data) of 9 pixels wide×10 pixels high from (−½, −1) to (7+½, 8) by a horizontal 6-tap FIR filter processing.

As described above, in a motion compensation of an entire image, it is required to prepare data of 14 pixels wide×14 pixels high as a reference image 600. However, in practice, when handling all of these areas at one data-read, there may occur a problem in embedding with a data bus width and the like in mind. With regard to this, in the horizontal 6-tap FIR filter processing, 14 pixels wide×10 pixels high surrounded by (−3, −1), (10, −1), (10, 8), (−3, 8) is referred. Accordingly, these images are once read to the internal register and the like.

When performing a computation of a ½ unit pixel (half-pel) image in a horizontal direction of 9 pixels wide×10 pixels high using eight computers, taking (0, 0) as an origin, an image 500 surrounded by (−½, −1), (6+½, −1), (6+½, 6), (−½, 6) (i.e., the area surrounded by the dotted line) is obtained. To derive the image 500, integer-pixel data of an image area surrounded by, starting from (−3, −1), (9, −1), (9, 6), (−3, 6) of the input image 600 is used. More specifically, the coordinate (−½, −1) is computed by substituting six pixels from (−3, −1) to (3, −1) to Expression 1. And, to obtain an image 501 (the area surrounded by the dashed-dotted line) surrounded by, starting from (½, −1), (7+½, −1), (7+½, 6), (½, 6), total eight pixels of horizontal pixels are computed as one line.

Similarly, same processing is performed on an image 502 (the area surrounded by the solid line) of 8 pixels wide×8 pixels high starting from (−½, 0), an image 503 (the area surrounded by the dashed-two dotted line) of 8 pixels wide×8 pixels high starting from (½, 0), an image 504 (the area surrounded by the thin dotted line) of 8 pixels wide×8 pixels high starting from (−½, 1) and an image 505 (the area surrounded by the thin solid line) of 8 pixels wide×8 pixels high starting from (½, 1).

According to the results from these processings, ½ unit pixel (half-pel) data in the horizontal direction of 9 pixels wide×10 pixels high can be obtained.

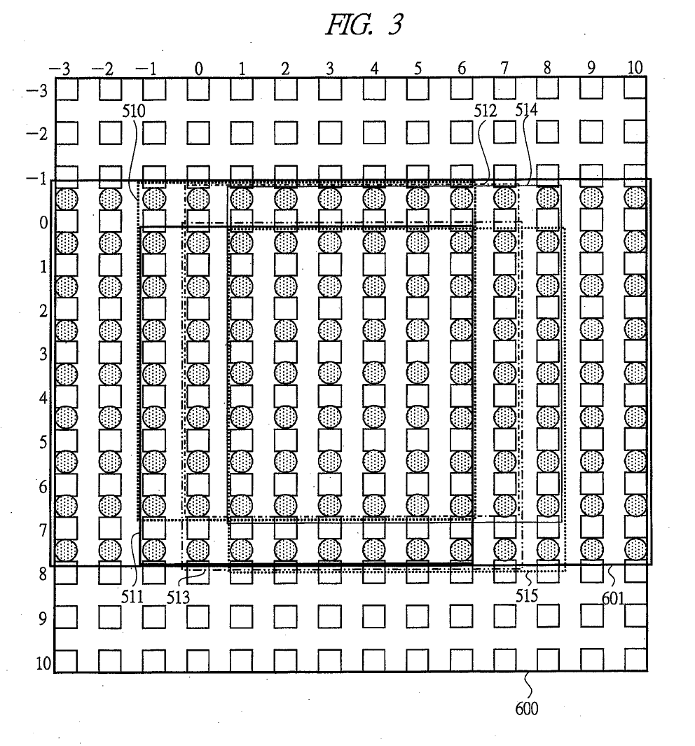

FIG. 3 is a diagram for describing a vertical 6-tap FIR filter processing. A filter processing for obtaining an image (image data) of 10 pixels wide×9 pixels high from (−1, −½) is shown. As with FIG. 2, when taking (0, 0) as an origin, to obtain an image 510 of 8 pixels wide×8 pixels high from (−1, −½) (the area surrounded by the dotted line), integer data of an image area surrounded by, starting from (−1, −3), (6, −3), (6, 9), (−1, 9) of the input image 600 is used. More specifically, also in the vertical direction, to derive (−1, ½), data of 6 pixels of (−1, −3), (−1, −2), (−1, −1), (−1, 0), (−1, 1), (−1, 2) is substituted to Expression 1. To derive this image 511 (the area surrounded by the solid line) of 10 pixels wide×9 pixels high starting from (−1, ½), the vertical pixels are computed by taking 9 pixels as one line, and data of one line is stored to a register inside a processor.

In addition, an image 512 starting from (0, −½) (the area surrounded by the dashed-dotted line), an image 513 starting from (0, ½) (the area surrounded by the dashed-two dotted line), an image 514 starting from (1, −½) (the area surrounded by the thin line), and an image 515 starting from (1, ½) (the area surrounded by the thin dotted line) are obtained by the same processing, and as a result, ½ unit pixel data of 9 pixels wide×10 pixels high is retained in an internal register.

Note that, in this example, since a ½ unit pixel (half-pel) in a diagonal direction which will be described later is derived by using this vertical ½ unit pixel, an image 601 from (−3, −½) to (10, −½), (10, 7+½), (−3, 7+½) is derived.

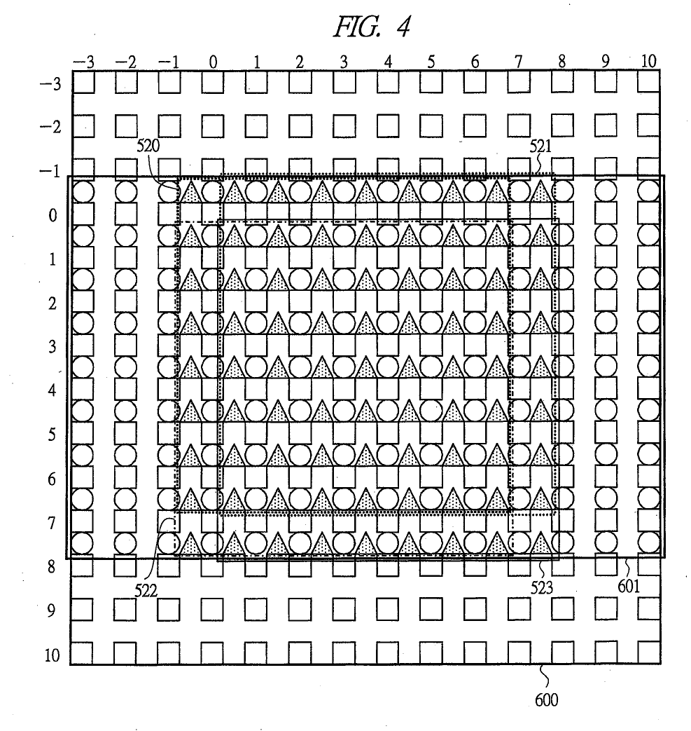

Based on these derivation results, pixels to a diagonal direction are computed. FIG. 4 is a diagram for describing this diagonal 6-tap FIR filter processing. The 6-tap FIR filter processing is also used to obtain the diagonal direction pixels, and the horizontal filter processing of FIG. 2 and the vertical filter processing of FIG. 3 are used to derive.

Images to be obtained by the diagonal filter processing are: an image 520 starting from (−½, −½) (the area surrounded by the dotted line); an image 521 starting from (½, −½) (the area surrounded by the thin dotted line); an image 522 starting from (−½, ½) (the area surrounded by the dashed-dotted line); and an image 523 starting from (½, ½) (the area surrounded by the solid line). The images are made into a composite image, so that an image of 9 pixels wide and 9 pixels high is created. At this time, reference pixel data required to obtain the image from the vertical filter processing is the image 601 from (−3, −½) to (10, 7+½). The horizontal 6-tap filter processing is performed on the image 601, thereby obtaining a filter image of diagonal 9 pixels wide×9 pixels high, and the result is stored in the internal register.

A ¼ unit pixel (quarter-pel) image is obtained by using the derived image data in vertical, horizontal, and diagonal directions. A ¼ unit pixel is derived by using Expression 2. Then, image data to be used is determined by a motion vector.

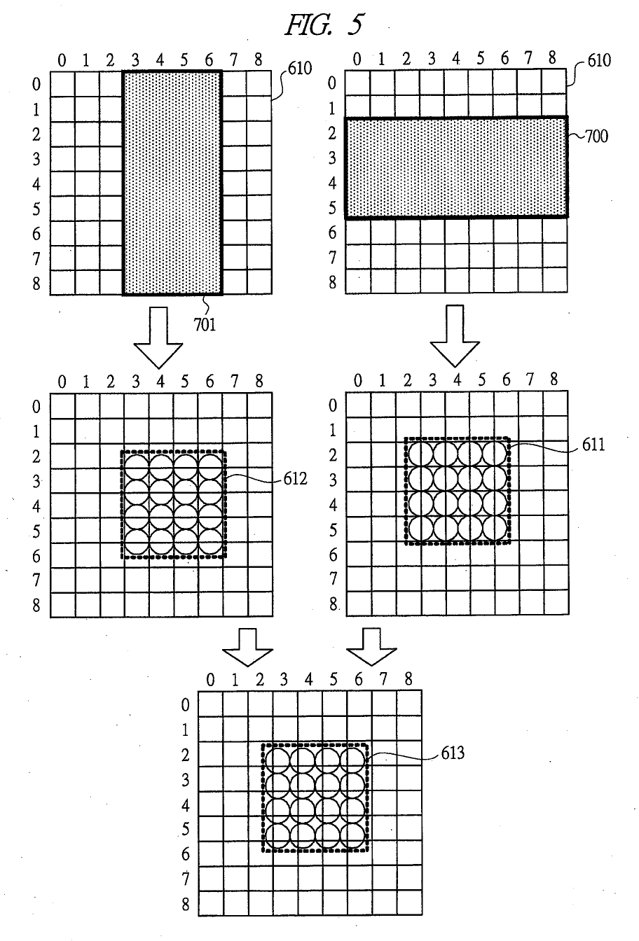

FIG. 5 shows a second-time filter processing to obtain a result of 4 pixels wide×4 pixels high. While the first-time filter processing is a 6-tap FIR filter processing, the second-time filter processing is a 2-tap filter processing. Accordingly, to obtain an image of 4×4 pixels, data of 9×9 pixels is used. The internal register stores data of 9 pixels wide to one entry, and a reference image 610 is stored in the internal register of total 9 entries. A method to obtain an image positioned at (½, ½) from the base coordinate shown in FIG. 5 uses image data 700 of entries 2 to 5 in the reference image 610 and performs the horizontal 6-tap filtering, so that a half-pel image 611 is created. And, while the vertical 6-tap filtering is performed using all the entries, a half-pel image 612 uses only 3rd byte to 6th byte counted in byte position from the left. By using the half-pel images 611 and 612, the 2-tap filtering which is the second-time filter processing is performed, thereby creating a quarter-pel image 613. Since one-line data is saved to the internal register in this manner, read and derivation can be executed easily.

The present invention has been made in consideration of performing the sequence of processings efficiently using limited hardware resources.

### First Embodiment

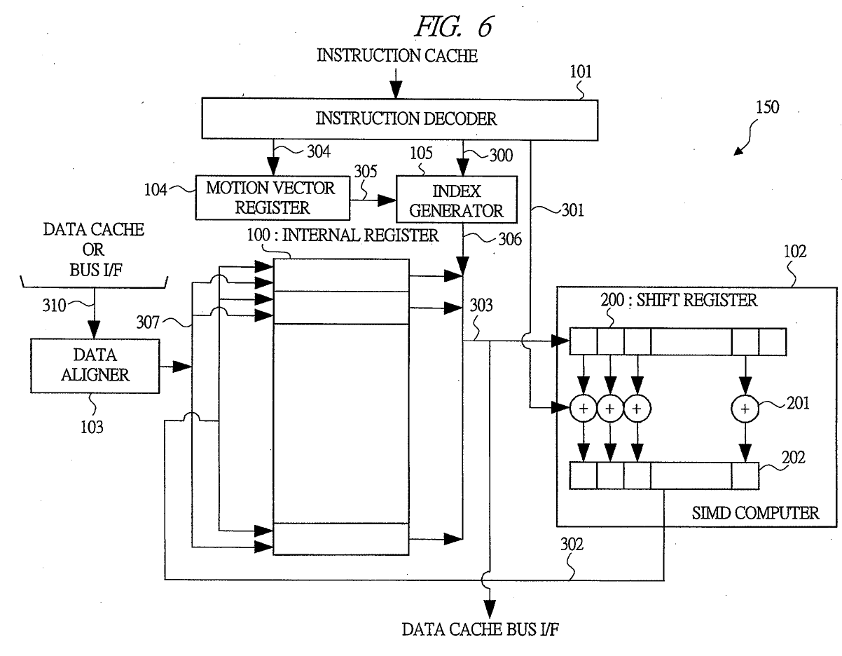

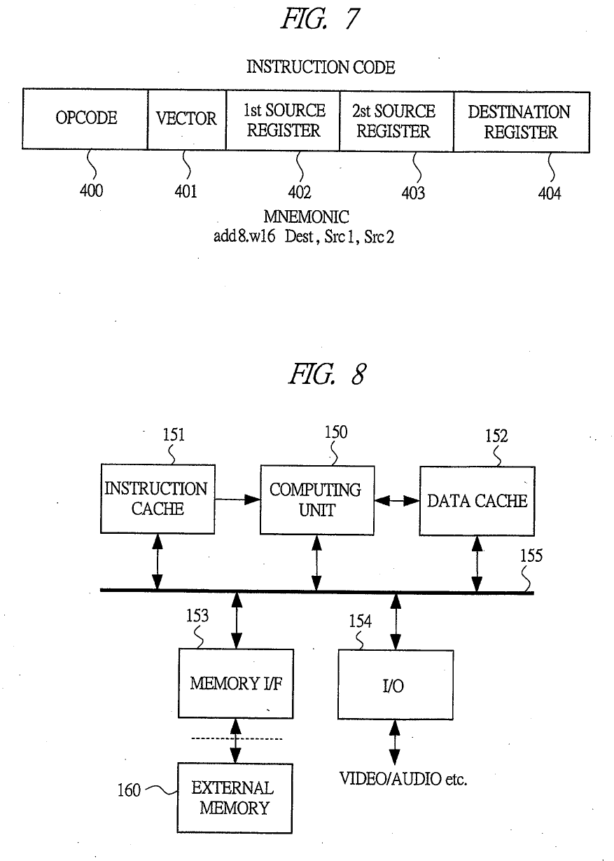

FIG. 6 is a schematic diagram showing a basic data flow of a computing unit 150 according to the present invention, and FIG. 7 is a configuration diagram showing a data system of a command to be sent to the computing unit 150. And, FIG. 8 is a schematic diagram of a processor embedding the computing unit 150.

The computing unit 150 is configured by respective modules of: an internal register 100; an SIMD (Single Instruction Stream, Multimedia Stream) computer 102; a data aligner 103; a motion vector register 104; and an index generator 105. And, the processor using this computing unit 150 is configured by: a command cache 151; a data cache 152; a memory I/F 153; an I/O 154; and an internal bus 155, other than the computing unit 150.

The internal register 100 is a register group for temporarily retaining reference data aligned and sectioned by the data aligner 103 per data. The register inside the processor described in the above section (About Simulated Processing) has simulated this internal register 100. Therefore, in the present invention, a main usage of the present register is to store the reference data to be used when performing the 6-tap FIR filter processing in horizontal, vertical, and diagonal directions and the pixel data after the 6-tap FIR filter processing for performing the 2-tap filter processing.

The command decoder 101 is a module which decodes a command transmitted from the command cache for commanding processings to the SIMD computer 102, the motion vector register 104, and the index generator 105. And, the command is analyzed to perform a processing of writing data to the motion vector register 104.

The SIMD computer 102 is a computer for handling an SIMD processing. Herein, the SIMD processing means a processing system which handles a plurality of data items by one command (command set), and is used when performing same kind of processings to a large amount of data. The SIMD computer 102 is configured by a shift register 200, a computer 201, and a computation result register 202. In the present invention, it is aimed to command a processing by one command for deriving a plurality of results at once from a plurality of reference pixels to derive a half-pel and a quarter-pel.

In the present invention, the SIMD computer 102 is only necessary to process the above mentioned Expression 1 and Expression 2. Meanwhile, there is no problem in providing versatility by providing other functions than that.

The data aligner 103 is a module which converts data transmitted from a data cache 152 or the bus I/F into valid data to memorize the same to the internal register 100.

The motion vector register 104 is a register which temporarily accumulates motion vector information read by the command decoder 101 from the command as motion vector data.

The index generator 105 is a module which generates an index for indexing which reference data accumulated in the internal register 100 is a computing object and how much the shift register 200 in the SIMD computer 102 shifts. The index generator 105 outputs an index by referring to the output from the command decoder 101 and the motion vector data accumulated in the motion vector register 104 with specifying an address of the internal register 100 and a register number.

The command cache 151 is connected to the internal bus 155, and a command code is supplied via the internal bus 155. And, the command code inputted to the command cache 151 is sent to the computing unit 150.

The data cache 152 is a module which supplies data which the computing unit 150 requires. When there is no proper data, the computing unit 150 reads required data from an external memory (not shown) via the memory I/F 153.

The memory I/F 153 is an interface unit for receiving supplies of command codes and data etc. from the external memory 160.

The I/O 154 is an interface unit for making connections with external processors not shown.

The internal bus 155 is a shared data communication path for making connections among the respective modules in the processor.

In the following, an operation in such a configuration will be described.

The command decoder 101 fetches the command stored in the command cache 151, and according to the decoding result, the reference image data (integer pixel data) is transferred to the data aligner 103 from the data cache 152 and an external memory to input the same to the internal register 100.

Normally, data from data cache and bus I/F has a data width of a power of 2. However, a data width of the internal register 100 and the number of computers in the SIMD computer 102 are not limited to powers of 2, and it is determined according to the embedding condition and so forth. According to control of the command decoder 101, the data aligner 103 handles the reference image data (integer pixel data) as follows.

When the data which the data aligner 103 received is smaller than the data width of the internal register 100, the data aligner 103 once retains the data until the data has the instructed data width and waits for data from the data cache or the bus I/F. When the data instructed by the command decoder 101 is obtained, the data aligner 103 writes the reference image data to the internal register 100.

The index generator 105 generates an index number of the internal register 100 by a reference index number 300 for accessing the internal register 100 by the command decoder 101 and motion vector data 305 stored in the motion vector register 104.

The data selected by the generated index number is received by the shift register 200 of the SIMD computer 102. Further, a computing control signal 301 is outputted by the command decoder 101 and sent to the computer 201 of the SIMD computer 102.

The data at this moment is the one which has been already adjusted by the data aligner 103, and the computer 201 is embedded to match the data width required for executing a computing command. More specifically, when eight computers 201 are provided as in the present invention, the data sent to the SIMD computer is also required to match eight computers.

Note that, when embedding the computer as much as required, it is feared to increase the circuit size. Therefore, it is necessary to consider reducing the number of embedding computers with the required performance in mind. It is needless to say that the required performance is achieved regardless of this reduction.

Even when write-back data 302 computed by the computer 201 does not have a number of bytes of powers of 2, as long as it is less than or equal to the data width of the internal register 100, writing can be done by one cycle of the write-back data.

In this manner, even when the computing processing requires a data width which is not a power of 2, it is able to improve processing performance by making the computer 201 and the internal register 100 match the data width.

FIG. 7 shows a command code for operating the computing unit 150 of FIG. 6 described in mnemonic style. The command code is configured by: an opcode (operation code) 400 indicating a processing method of the computer 201; a computing width 401; a first source register number 402 indicating where the computing data entered to the computer 201 exists in the internal register 100; a second source register number 403; and a destination register number 404 indicating where in the internal register 100 to store the computation result.

A feature of the command code is to have a field of the computing width 401 indicating a width of computing. This computing width 401 is an attribute value indicating the data width of the internal register 100. Meanwhile, an upper limit of the attribute value is not limited by the number of the computer 201 and the data width of the internal register 100. In this case, computation is performed for over 2 cycles to output result.

The mnemonic of the present invention is needed to describe a data width, and a command code is generated according to the mnemonic. Meanwhile, the computing width 401 is not always necessary to be written. When the data width is determined uniquely by the opcode 400, it is not necessary to describe. For example, an 8-bit add command is computed in parallel for a 16-byte computing width, i.e., 16 parallel computations, it is assumed to describe as “add8.w16”.

FIG. 8 is a schematic diagram of a processor embedding the computing unit 150 of FIG. 6. Basically, it is assumed to change the order of arranging the data by the data aligner 103 inside the computing unit 150, and thus the configuration of the computing unit 150 is not different from that of general processors.

When outputting a computation result by a store command or the like, the result is once sent to the data cache 152 or retained by the external memory via the memory I/F 153.

And, data exchange with the I/O 154 which is an interface between low-speed devices for video and audio can be performed through the internal bus 155.

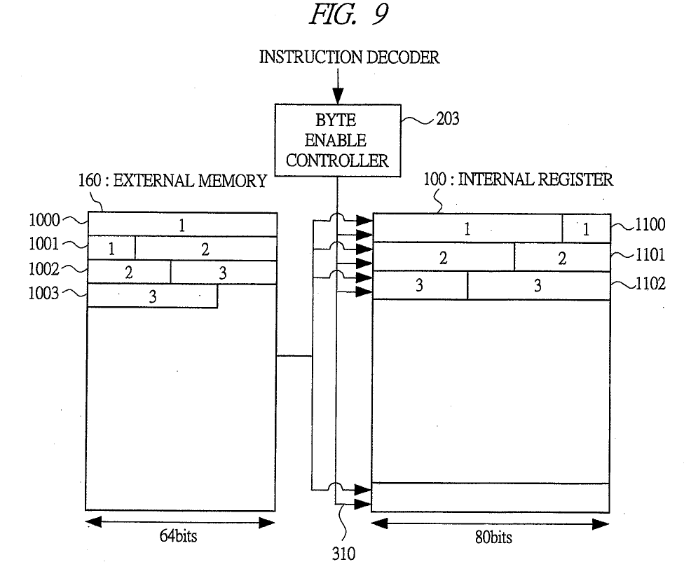

FIG. 9 shows one method to achieve the data aligner 103. The external memory 160 is 64-bit wide, and the internal register 100 is 80-bit wide.

According to a command from the command decoder 101, a byte enable control unit 203 generates an address signal. According to this address signal, an address of the external memory is specified. When writing data to be read from the external memory 160 to the internal register 100, an enable signal which is a write timing is generated. A position available for writing to the internal register 100 can be determined by a lower bit of the address in a first-time read of the external memory 160.

In other words, a data line 1000 on the external memory aligned is capable of writing all data to the internal register data 1100 by the byte enable control unit 203.

In the next cycle, remained data of the internal register data 1100 is read from a data line 1001 of the external memory 160, and a byte enable signal 310 is generated by the byte enable control unit 203 and written to the internal register 1100.

At this time, among the data read from the external memory, it is possible to reduce read cycles by using temporarily retaining data which has not been written to the internal register 100 in the next access (how to temporarily retain is not shown in FIG. 9).

FIG. 10 shows a data flow in performing a second-time filter processing as an image processing. In the present diagram, a 6-tap filter processing is performed using 14-byte data so that half-pel data of 9-byte in all vertical, horizontal, and diagonal directions is created. Then, a 2-tap filter processing is performed using also the 9-byte data, so that 8-byte quarter-pel data is created as a result.

First, proper data among 14-byte data 500 is entered to the SIMD computer 102. Since a result of 9-byte is needed at this time, eight computers 201 of the SIMD computer 103 are operated.

To perform the 6-tap filter processing, the data enter is performed for 6 cycles reducing 1-byte per cycle to enter the data to the SIMD computer 102. Therefore, the number of bytes is required to be 9 byte+6 taps−1, i.e., the number of bytes required to enter is 14 bytes.

It is able to enter data shifted by 1 byte by the shift register 200 to the SIMD computer 102, and a 9-byte computation result is obtained after 6 cycles. The computation result is once written back to the internal register 100, and reused by the next 2-tap filtering. At this time, when the data width of the internal register is not 9 bytes, parts of other than 9 bytes can be any value.

The 9-byte data stored in the internal register 100 is entered to the computer 201 for the next 2-tap processing. At this time, eight computers 201 are operated. To perform the 2-tap processing, the first 8 bytes are entered in the first cycle, and data shifted by 1-byte is entered in the next cycle. At the moment a processing of the second cycle is ended, an 8-byte result can be obtained, so that the computation result 202 is written back to the internal register 100. In this manner, the 2-tap filter processing can be achieved after the 6-tap filter processing.

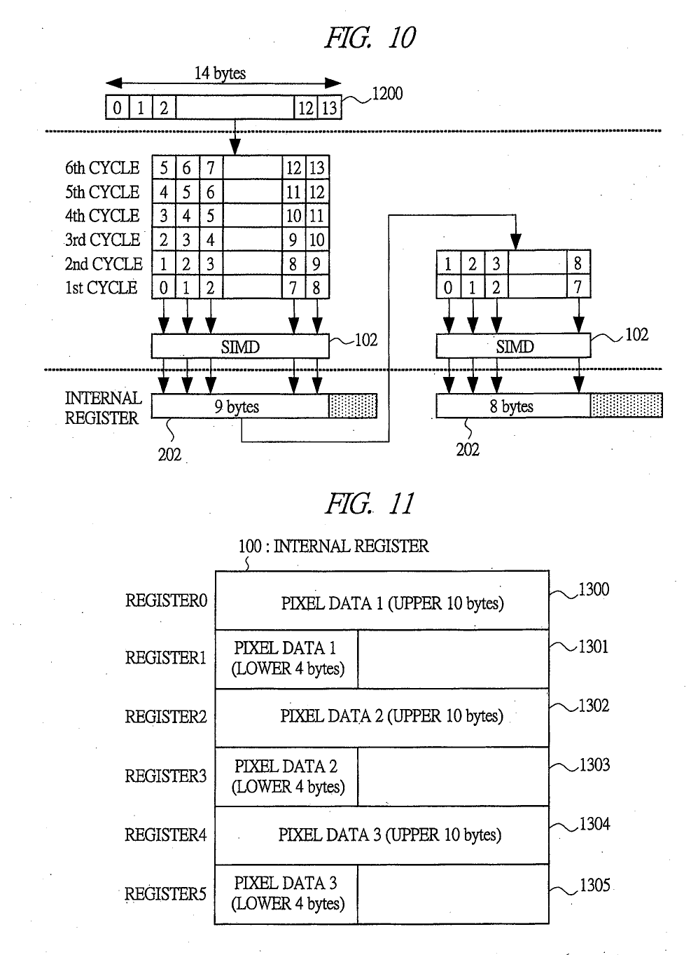

FIG. 11 shows a method of storing 14-byte wide data in the case where the internal register 100 is defined to have 10-byte width. While the data width of the internal register 100 is normally defined to match the data width of 14 bytes, when the number of times to use the maximum width is significantly small to the whole processing, it is able to reduce the circuit size by storing data across a plurality of register for reducing the circuit size of the internal register. Of course, the number of read ports is 2 in this case.

Data 1300 and data 1301 are stored in a register 0 and a register 1, thereby configuring 14 bytes of pixel data 1. Similarly, 14 bytes of pixel data 2 is configured by using data 1302 and data 1303 of a register 2 and a register 3. To use the pixel data, for example, by designating a register 4 and describing data width 14 by a mnemonic code, data of the register 4 and a register 5 can be entered to the shift register 200.

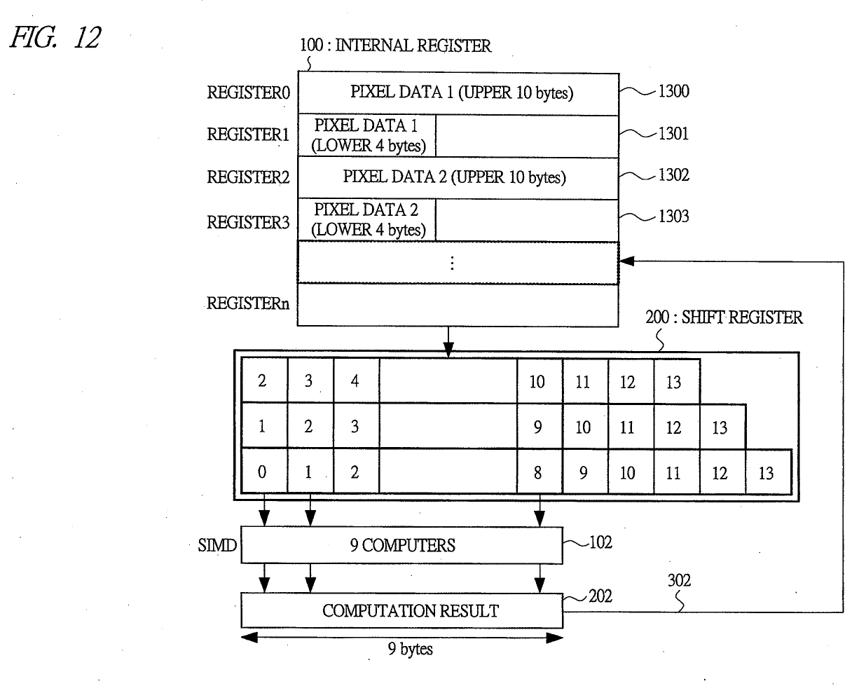

FIG. 12 shows a filter processing by a computer in the case where 14-byte wide data is stored to the 10-byte wide internal register 100.

In image compression techniques, in the case where a 2-tap filter processing is performed after performing a 6-tap filter processing, an image of 14 pixels to 9 pixels is created, and an image of 8 pixels is further created by the 2-tap filter processing. In such a processing, it is required to retain data for 14 pixels to the internal register 100, and among image data 1 of the 14 pixels of the first line, upper 10 bytes are stored to the register 0 as the data 1300, and lower 4 bytes are stored to the register 1 as the data 1301. These data items are entered to the SIMD computer 102 and well-formed by the shift register 200. The horizontal 6-tap filter processing is obtained by the first 6 pixels of the 14-pixel data. Therefore, it is able to obtain the 6-tap filter processing by entering data to the computer 201 by 1-byte in each cycle by the shift register 200. The computation result 202 outputted after 6 cycles is written back to the internal register 100 and entered to the next filter processing.

According to the above-described configuration, even in the case where the computing processing requires a data width which is not a power of 2, it is possible to improve processing performance by matching the computer 201 and the internal register to the width.

### Second Embodiment

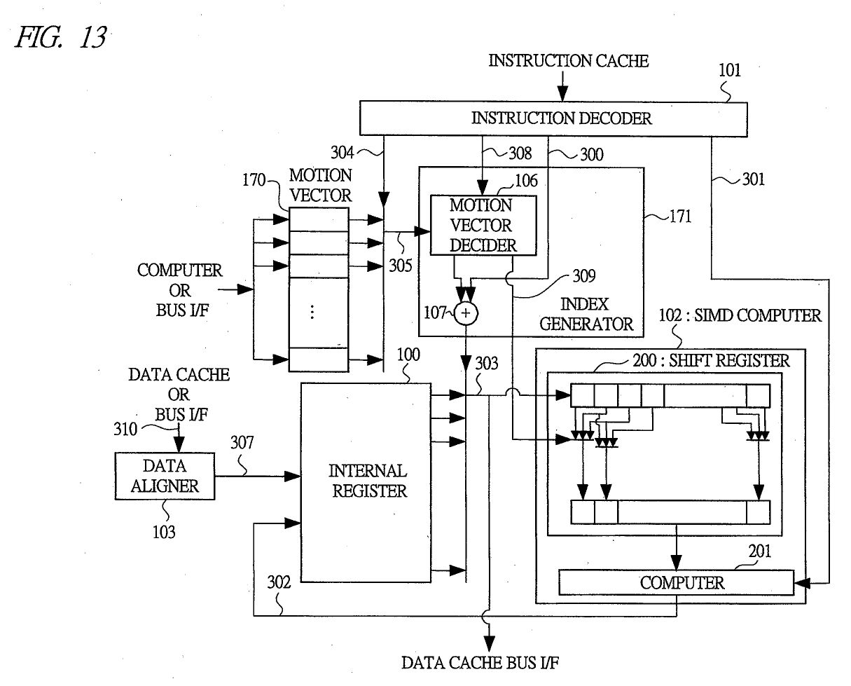

FIG. 13 shows a data flow of a computing unit capable of performing a filter processing by one command by changing data to enter corresponding to motion vectors.

A different part from the computing unit of the first embodiment is to exchange the motion vector register 104 by a vector register 170 so that the bus I/F can write a simulated motion vector processing and to exchange the index generator 105 by an index generator 171.

Actually, in H.264, motion vector processing patterns to one block are limited to 40 to 50 processings.

Accordingly, all the processing patterns (motion vector) are prepared to be able to be written to the vector register 170 as data. And, a vector decider 106 extracts the motion vector from the motion vector register 170 and sets an address in the internal register 100 to perform a proper processing by the motion vector decider 106, thereby enabling setting of the address to the shift register 200 of the SIMD computer 102.

In the following, operations after write of the motion vector register 170 will be described in detail.

To access the internal register 100 by the command decoder 101, proper data (motion vector 305) is selected from the motion vector register 170 by a motion vector selecting signal 304, and the motion vector decider 106 refers to the proper motion vector 305.

Further, according to a motion vector decider controlling signal 308 outputted from the command decoder 101, the internal computing system using the referencing motion vector 305 is changed. For example, in the case of two-stage filter processing, it is used for changing a processing systems of the first stage and that of the second stage.

An offset value determined by the motion vector decider 106 and a basic index number 300 are added, and register data 303 to be inputted to the SIMD computer 102 is selected. The selected data is received by the shift register 200. Thereafter, the command decoder 101 further outputs a computing control signal 301, and a type of computing is notified to the computer 201 of the SIMD computer 102.

And, by a control signal line 309 for outputting data to the shift register 200 by the motion vector decider 106, weighting of output data from the shift register 200 is done, and the computer 201 performs a computing processing using the weighted data.

While the data of the shift register 200 is sent to the computer 201, at this time, the number of embedded computers 201 is matched to the data width which a computing command requires. More specifically, when nine computation results are needed as the computation result, the number of embedding computer 201 is also nine. When the number of embedding computers is increased, it may pose an increase of the circuit size. Thus, it is possible to reduce the number of embedding computers in consideration of required performance.

In this manner, even when write-back data 302 computed by the computer 201 does not have a number of bytes of a power of two, as long as it is smaller than the data width of the internal register 100, the write-back data 302 can be written in one cycle.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention is effective in performing a data processing which requires a plurality of times of filter processings. While the present specification cited image decoding/encoding of H.264/AVC etc. as examples, it is not necessarily limited to this and the invention is also applicable to a processing of voice and so forth.

What is claimed is:

1. A computing unit comprising: an SIMD computer including a plurality of computers capable of executing a first computing processing for performing one specific processing in a first cycle and a second computing processing for performing another specific processing in a second cycle which is different from the first cycle; and a command decoder,
wherein the command decoder can define a number of computers to be operated among the plurality of computers according to an entered command code.

2. The computing unit according to claim 1,
wherein the SIMD computer further includes a shift register, and
wherein the command decoder enters data to the shift register according to an entered command code.

3. The computing unit according to claim 2 further comprising an internal register and an index generator,
wherein an address of the internal register is outputted according to an input from the command decoder, and data in the internal register is entered to the shift register referring to the address.

4. The computing unit according to claim 3,
wherein the first cycle is configured by a predetermined number of clock cycles and a first computation result is outputted per the first cycle, and the data in the shift register is shifted after each clock cycle in the first cycle ends.

5. The computing unit according to claim 4,
wherein the first computation result is stored in the internal register.

6. The computing unit according to claim 5,
wherein the second cycle is configured by a predetermined number of clock cycles and a second computation result is outputted per the second cycle, and the data in the shift register is shifted after each clock cycle in the second cycle ends.

7. The computing unit according to claim 6,
wherein the second computation result is stored in the internal register.

8. The computing unit according to claim 7,
wherein the first computation result is entered to the second computation result.

9. An image filtering device comprising: a shift register; an SIMD computer including a plurality of computers capable of executing a first computing processing for performing one specific processing in a first cycle and a second computing processing for performing another specific processing in a second cycle which is different from the first cycle; a command decoder; an internal register; an index generator; and a motion vector register,
wherein the command decoder defines a number of computers to be operated among the plurality of computers according to an entered command code,
wherein the command decoder accumulates motion vector data to the motion vector register according to an entered command code and outputs the same, and
wherein the index generator outputs an address in the internal register referring to an output of the command decoder and the motion vector data, and the data in the internal register is entered to the shift register referring to the address so as to be computed by the SIMD computer.

10. An image filtering device comprising: a shift register; an SIMD computer including a plurality of computers capable of executing a first computing processing for performing one specific processing in a first cycle and a second computing processing for performing another specific processing in a second cycle which is different from the first cycle; a command decoder; an internal register; an index generator; and a motion vector register,
wherein the command decoder defines a number of computers to be operated among the plurality of computers according to an entered command code,
wherein the motion vector register outputs proper motion vector data to the index generator according to an output from the command decoder, and
wherein the index generator outputs an address in the internal register referring to an output of the command decoder and the motion vector data, and the data in the internal register is entered to the shift register referring to the address so as to be computed by the SIMD computer.

11. The computing unit according to claim 1 further comprising a motion vector register which retains a motion vector, wherein the command decoder decodes a command for allowing a motion vector register designated by a command code to be selectable according to a command code in the first computing processing and the second computing processing.

12. The computing unit according to claim 11, wherein the command decoder decodes a command for changing a processing system to perform a vertical filtering or a horizontal filtering of the first computing processing or the second processing according to a motion vector outputted from a selected motion vector register.
